(19) United States
(12) Patent Application Publication
(10) Pub. No.: US 2002/0166280 A1
(43) Pub. Date: Nov. 14, 2002

(54) Holder for a fishing rod

(76) Inventors: Thomas J. O'Grady SR., Franklin, MA (US); Thomas J. O'Grady JR., Franklin, MA (US)

Correspondence Address: David J. Cole, 7 Lakeshore Drive, Medway, MA, 02053-1034, US

(21) Appl. No.: 09/850,986

(22) Filed: May 8, 2001

(51) Int. Cl. A01K 97/10

(52) U.S. Cl. 43/21.2

(57) ABSTRACT

A holder (10) for a fishing rod (24) comprises an elongate support member (12) having one end (16) adapted to penetrate the ground; and a rod retaining member (14) secured adjacent the opposed end of the support member (12), the rod retaining member having an elongate aperture of sufficient size to accommodate part of the handle of a fishing rod (24). The rod retaining member (14) is secured to the support member (12) such that when the support member (12) is disposed vertically, the aperture through the rod retaining member (14) is disposed at an angle of from about 10 to about 30° to the horizontal. A second support member (26) may be provided to prevent rotation of the holder (10) when in use.

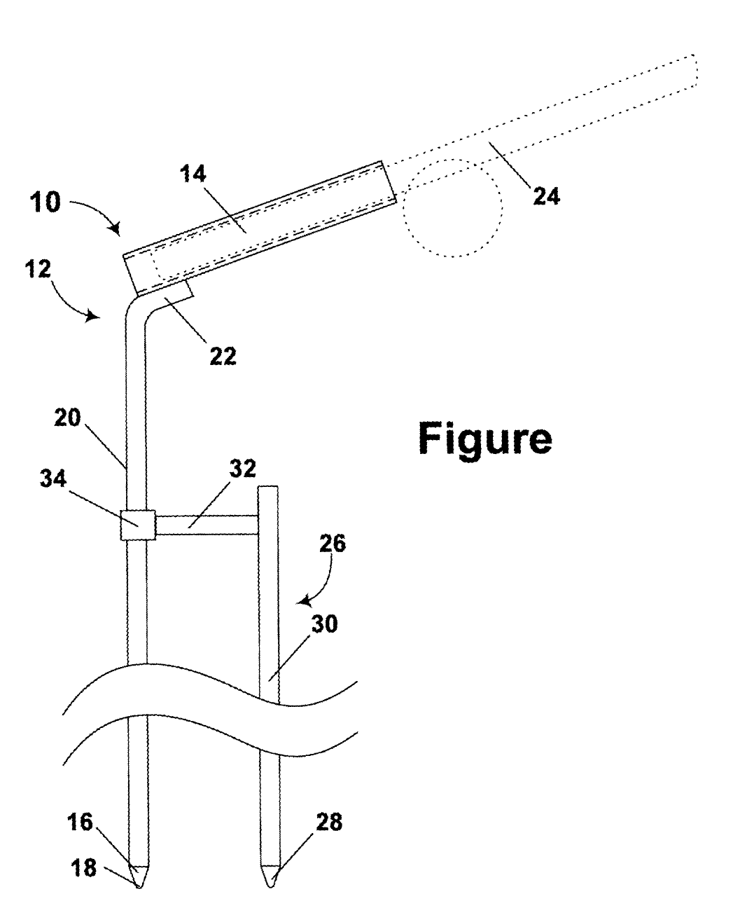

### BACKGROUND OF THE INVENTION

This invention relates to a holder for a fishing rod.

In many types of fishing, it is customary for the fisherman to make use of a holder for the fishing rod. For example, in game fishing, where large and powerful fish are being caught, it is customary for the fisherman to use a so-called “fighting chair” which is rotatably mounted upon the deck of the fishing boat and which has associated therewith a fish fighting apparatus which can support the rod and relieve the fisherman of part of the enormous strain which a large game fish can impose upon a rod. Such fish fighting apparatus, which may be regarded as a form of rod holder, is typically elaborate and costly, as illustrated, for example, in U.S. Pat. No. 6,089,652, issued Jul. 18, 2000 to Miller, Sr.

When catching smaller fish, such as those typically found in fresh water, the fisherman does not need assistance in coping with the lesser strains imposed upon the rod. However, many fisherman prefer to use a fishing rod holder to relieve them of the need to hold the rod manually during long fishing sessions; once a fish takes the bait, the fisherman removes the fishing rod for the holder and lands the fish manually.

One simple, common type of fishing rod holder used in this situation has essentially the form of a stirrup, having a central post which is pushed into the ground and a pair of “horns” extending in opposite directions from the upper end of the central post. The reel end of the rod rests upon the ground, with the reel positioned between this end of the rod and the holder, and with the upper portion of the rod on the opposed side of the holder. A variant of this type of holder, equipped with a cross-piece for controlling the depth to which the central post penetrates the ground, is illustrated in U.S. Pat. No. 5,488,798, issued Feb. 6, 1996 to Beachel. Similar types of holders are illustrated in U.S. Pat. No. 5,934,004, issued Aug. 10, 1999 to Koe, and in U.S. Pat. No. 4,938,446, issued Jul. 3, 1990 to Williams.

Other types of rod holder use a tube, open at one or both ends, into which the reel end of the rod is inserted. Holders of this type are illustrated in, for example, U.S. Pat. No. 3,058,251, issued May 9, 1961 to Brooks (a very elaborate holder, costly to manufacture, featuring an adjustable arcuate cradle atop a vertical post, and a signaling means for indicating a bite); U.S. Pat. No. 4,748,762, issued Jun. 7, 1988 to Campbell; U.S. Pat. No. 4,486,968, issued Dec. 11, 1984 to Gould; U.S. Pat. No. 4,443,963, issued Apr. 24, 1984 to Braaten; U.S. Pat. No. 5,349,775, issued Sep. 24, 1994 to Mondares; U.S. Pat. No. 5,566,495, issued Oct. 22, 1996 to Kim et al.; U.S. Pat. No. 5,625,974, issued May 6, 1997 to Demaio (in which a tube is supported upon a stem provided at its lower end with parallel two cross-pieces forming a H-shape; the holder is intended to be mounted upon a dock or similar structure with one cross-piece above and one below the planks of the dock, with the result that the inclination of the tube to the horizontal depends upon the thickness of these planks); U.S. Pat. No. 4,650,146, issued Mar. 17, 1987 to Duke (a dual rod holder intended for surf fishing and equipped with a flotation insert); U.S. Pat. No. 4,086,716, issued May 2, 1978 to Donahue (a tube resting upon an inclined rod which is itself supported by a biped mount similar to that conventionally used to support an infantry mortar); U.S. Pat. No. 5,546,693, issued Aug. 20, 1996 to Stockton et al. (a holder comprising two tubular sections pivotable relative to one another); U.S. Pat. No. 5,383,299, issued Jan. 24, 1995 to Smelker; U.S. Pat. No. 5,501,028, issued Mar. 26, 1996 to Hull et al.; and U.S. Pat. No. 3,360,224, issued Dec. 26, 1967 to Baumann, Jr. U.S. Pat. No. 4,407,089, issued Oct. 4, 1983 to Miller describes a variant of tube-based holder in which a collar bearing a stud is releasably secured to the reel end of the rod, this stud engaging a slot provided in the forward end of a tube.

Still other types of rod holders are disclosed in various prior art patents. For example, U.S. Pat. No. 4,581,838, issued Apr. 15, 1986 to Moon, describes a holder in which the rod is directly supported by a stake driven into the ground and a ground brace member and a rod support member are provided to hold the stake and the rod in their correct positions. Also, U.S. Pat. No. 5,321,904, issued Jun. 21, 1994 to Benson; U.S. Pat. No. 5,662,306, issued Sep. 2, 1997 to Dysarz; U.S. Pat. No. 4,007,902, issued Feb. 15, 1977 to Pettee; and U.S. Pat. No. 5,184,797, issued Feb. 9, 1993 to Hurner, all describe various forms of rod holder intended for attachment to the deck or hull of a fishing vessel.

Despite the number and variety of prior art fishing rod holders, as evidenced by the numerous patents previously mentioned, curiously little attention appears to have been paid to optimizing the ergonomics of such rod holders, that is to say to ensuring that the form of the holder makes it easy for the fisherman to use. The holder should hold the rod securely in a position such that the fisherman can easily observe the tip of the rod in order to determine when a fish bites. Once such a bite does occur, the position of the rod should not impose excessive drag upon the line as the fish pulls line off the rod, since any excessive drag may be felt by the fish, and cause the fish to release the bait. Furthermore, as already indicated, once the fisherman detects a bite, he needs to remove the rod from the holder in order to land the fish, and it is important that this removal of the rod from the holder be achieved without any such jerk or impact upon the rod, since any sudden force imposed upon the rod by such a jerk or impact may be felt by the fish and cause the fish to be lost.

This invention provides such a rod holder which meets the aforementioned requirements and yet which is simple to manufacture and use.

### SUMMARY OF THE INVENTION

Accordingly, this invention provides a holder for a fishing rod, this holder comprising an elongate support member having one end adapted to penetrate the ground; and a rod retaining member secured adjacent the opposed end of the support member, the rod retaining member having walls defining an elongate aperture extending through the rod retaining member, this aperture being of sufficient size to accommodate part of the handle of a fishing rod, the rod retaining member being secured to the support member such that when the support member is disposed vertically, the aperture through the rod retaining member is disposed at an angle of from about 10 to about 30° to the horizontal.

### BRIEF DESCRIPTION OF THE DRAWING

The sole Figure of the accompanying drawings shows a side elevation of a preferred rod holder of the invention, in use with a rod, the rod being shown in broken lines.

### DETAILED DESCRIPTION OF THE INVENTION

As already mentioned, the present invention provides a rod holder comprising a support member and a rod retaining member. The support member is designed to have its lower end forced into the ground (a term which is used herein in a broad sense to cover sandy, pebbly or muddy beaches or foreshores, as well as the banks of rivers, streams, lakes and the like) so that the support member extends substantially vertically. The rod retaining member is secured adjacent the upper end of the support member and has an aperture into which the fisherman inserts part of the handle of his fishing rod. The rod retaining member is secured to the support member such that when the support member is disposed vertically, the aperture through the rod retaining member is disposed at an angle of from about 10 to about 30° to the horizontal, preferably at an angle of about 15 to about 25° to the horizontal, and most desirably substantially 20° to the horizontal. The relatively low inclination of the rod to the horizontal ensures that when a fish bites, the rod does not impose an excessive resistance to the fish pulling line off the reel.

It has been found that both the size of the aperture in the rod retaining member, and the ratio of the length of the aperture to its greatest cross-sectional dimension, are important in ensuring that the rod retaining member holds the rod securely but permits the fisherman to remove the rod from the holder smoothly and without jerking the rod once the fisherman has detected a bite. Although the preferred dimensions of the aperture will vary somewhat with the type of rod with which the holder is intended to be used, in general it is preferred that the aperture be prismatic or cylindrical and have a length of from about 3 to about 7 (desirably about 4 to about 6) times is greatest cross-sectional dimension (the diameter in the case of a cylindrical aperture). Preferably, the minimum cross-sectional dimension of the aperture is from about 1.2 to about 1.8 inches (about 30 to about 46 mm.), and the length of the aperture is in the range of about 6 to about 12 inches (about 152 to about 305 mm.).

To facilitate insertion of the support member into the ground, the lower end of this member is desirably provided with a substantially conical section adapted to penetrate the ground. However, it is not advisable for the tip of such a conical section to come to a sharp point, since such a sharp point may scratch or puncture the skin of the fisherman or a companion as the support member is being removed from the ground, and since the tip may have been in contact with soil for an extended period, any such scratch or puncture might expose the injured person to tetanus or some other soil-borne disease. To avoid this risk, desirably the tip of the substantially conical section is rounded to form a substantially hemispherical section; the radius of such a substantially hemispherical section is preferably from about 0.03 to about 0.1 inch (about 0.76 to about 2.5 mm.).

The support member may be of any length which places the rod retaining member at a convenient height for the fisherman to reach, due allowance being made for the need for the lower end of the support member to penetrate a sufficient distance into the ground to ensure that the support member is firmly held in position, especially if the support member needs to be inserted into wet beach sand or some similar soft, yielding material. In general, the support member will have a length of from about 12 to about 60 inches (about 305 to 1523 mm.), and preferably from about 24 to about 48 inches (about 609 to 1218 mm.).

In a preferred form of the rod holder of the present invention, the support member has a main section, having one end adapted to penetrate the ground, and an auxiliary section secured to the opposed end of the main section, the auxiliary section being inclined at an angle of from about 60° to about 80° to the length of the main section, and the rod retaining member being secured to the auxiliary section. The provision of such an auxiliary section (which can conveniently be provided by bending a single metal rod to form both the main and the auxiliary sections) provides a large area of contact between the auxiliary section and the rod retaining member, and this large area of contact allows for a strong weld between these two members.

As will readily be apparent to any mechanical engineer, if (as will typically be the case) the support member is formed from a simple metal rod, even if the support member is inserted firmly into the ground, the resistance to rotation of the support member will be relatively low. Such relatively free rotation of the support member is generally undesirable, since, for example, rotation of the support member, caused by movement of the rod when a fish bites, may cause the rod to move to a position which is inconvenient for the fisherman, thus increasing the risk that the fisherman may jerk the rod in removing it from the rod retaining member. To prevent rotation of the support member, the rod holder of the present invention may further comprise a second support member having one end adapted to penetrate the ground such that the second support member extends substantially parallel to but spaced from the support member, the second support member being secured or securable to the support member such that when both the support member and the second support member penetrate the ground, the second support member prevents rotation of the support member. Conveniently, the second support member has a main section having one end adapted to penetrate the ground and a collar section disposed adjacent the opposed end of the main section and capable of surrounding the support member, the collar section being provided with securing means, for example a set screw, arranged to releasably secure the collar section to the support member.

The preferred rod holder (generally designated 10) shown in the sole Figure of the accompanying drawing comprises a support member (generally designated 12) and a rod retaining member 14. The support member 12 comprises a ground-penetrating section 16, which is generally conical in form and 0.86 inch (22 mm.) in length, the tip portion 18 of this section 16 being substantially hemispherical in form and having a diameter of about 0.06 inch (1.5 mm.). The support member 12 further comprises a main section 20 having a length of 35 inches (888 mm.) and an auxiliary section 22 having a length of 1.56 inch (40 mm.) and disposed at an angle of 70° to the axis of the main section 20.

The support member 12 is formed from a single piece of cylindrical metal rod 0.5 inch (13 mm.) in diameter. For obvious reasons, the support member 12 should be corrosion-resistant and for this purpose the metal rod may be formed of aluminum or galvanized steel. The ground-penetrating section 16 and the tip 18 are formed at one end of the rod by any convenient machining process, while the opposed end of the rod is bent to form the auxiliary section 22.

The rod retaining member 14 has the form of a hollow aluminum tube of square cross-section (a cylindrical or other polygonal, for example hexagonal, tube may alternatively be used), the tube being 1.5 inch (38 mm.) square, having a wall thickness of 0.06 inch (1.5 mm.) and being 9.25 inch (235 mm.) long and open at both ends. Thus, the rod retaining member 14 provides a square aperture into which the reel end of a rod (generally designated 24) may be inserted, and from which the rod may readily be removed.

The rod holder 10 is used by manually forcing the ground-penetrating section 16 into the ground, typically for a distance of 6 to 12 inches (152 to 305 mm.), so that the main section 20 of the support member 12 extends substantially vertically, thus placing the upper end of this main section 20 at a height of about 23 to about 29 inches (about 584 to about 736 mm.) above the surface of the ground. With the main section 20 thus disposed substantially vertically, the auxiliary section 22 and the rod retaining member 14 extend upwardly at an angle of about 20° to the horizontal, this angle having been found to be optimal to enable the fisherman to remove the rod 24 easily and rapidly from the rod retaining member 14 without jerking the line attached to the rod 24.

The Figure further shows the rod holder 10 being used in combination with a second support member (generally designated 26) having a ground-penetrating section 28 generally similar to the section 16 of the rod holder 10, a main section 30 which extends vertically, parallel to the main section 20, an auxiliary section 32 which extends substantially horizontally, and a collar section 34 which surrounds the upper end of the main section 20 of the rod holder 10. The collar section 34 is provided with a set screw 36 used to releasably secure the collar section 34 to the main section 20.

As already explained, the function of the second support member 26 is to prevent rotation of the support member 12 of the rod holder 10, thus ensuring that the rod 24 remains in a constant position relative to the fisherman. The second support member is used in the following manner. Before the support member 12 is forced into the ground, the collar section 34 is slid upwardly over the ground-penetrating section 16 until is rests around the upper portion of the main section 20, but the set screw 36 is retracted so that it does not engage the main section 20. The rod holder 10 is then placed in position as previously described, and thereafter the ground-penetrating section 28 of the second support member 26 is forced into the ground at a point spaced from the ground-penetrating section 16 so that the main section 30 of the second support member 26 extends vertically. The set screw 36 is then tightened so that it engages the main section 20, thus preventing rotation of the rod holder 10 about the axis of its main section 20.

From the foregoing, it will be seen that this invention provides a rod holder which is simple and inexpensive to construct yet which does impose excessive drag upon the line of a rod placed in the holder when a fish bites, and which permits the fisherman to remove the rod from the holder without jerking the rod or the line attached thereto.

It will be apparent to those skilled in the art that numerous changes and variations can be made in the specific embodiments of the invention described above without departing from the scope of the present invention. Accordingly, the foregoing description is to be construed in an illustrative and not in a limitative sense, the scope of the invention being defined solely by the appended claims.

What I claim is:

1. A holder for a fishing rod, the holder comprising:
an elongate support member having one end adapted to penetrate the ground; and
a rod retaining member secured adjacent the opposed end of the support member, the rod retaining member having walls defining an elongate aperture extending through the rod retaining member, this aperture being of sufficient size to accommodate part of the handle of a fishing rod, the rod retaining member being secured to the support member such that when the support member is disposed vertically, the aperture through the rod retaining member is disposed at an angle of from about 10 to about 30° to the horizontal.

2. A holder according to claim 1 wherein the rod retaining member is secured to the support member such that when the support member is disposed vertically, the aperture through the rod retaining member is disposed at an angle of from about 15 to about 25° to the horizontal.

3. A holder according to claim 2 wherein the rod retaining member is secured to the support member such that when the support member is disposed vertically, the aperture through the rod retaining member is disposed at an angle of from substantially 20° to the horizontal.

4. A holder according to claim 1 wherein the aperture in the rod retaining member is prismatic or cylindrical and has a length of from about 3 to about 7 times its greatest cross-sectional dimension.

5. A holder according to claim 4 wherein the aperture has a length of from about 4 to about 6 times its greatest cross-sectional dimension.

6. A holder according to claim 4 wherein the minimum cross-sectional dimension of the aperture is from about 1.2 to about 1.8 inches.

7. A holder according to claim 1 wherein the aperture has a length in the range of from about 6 to about 12 inches.

8. A holder according to claim 1 wherein said one end of the support member is provided with a substantially conical section adapted to penetrate the ground.

9. A holder according to claim 8 wherein the tip of the substantially conical section is rounded to form a substantially hemispherical section having a radius of from about 0.03 to about 0.1 inch.

10. A holder according to claim 1 wherein the support member has a length in the range of from about 12 to about 60 inches.

11. A holder according to claim 10 wherein the support member has a length in the range of from about 24 to about 48 inches.

12. A holder according to claim 1 wherein the support member has a main section, having one end adapted to penetrate the ground, and an auxiliary section secured to the opposed end of the main section, the auxiliary section being inclined at an angle of from about 60° to about 80° to the length of the main section, and the rod retaining member being secured to the auxiliary section.

13. A holder according to claim 1 further comprising a second support member having one end adapted to penetrate the ground such that the second support member extends substantially parallel to but spaced from the support member, the second support member being secured or securable to the support member such that when both the support member and the second support member penetrate the ground, the second support member prevents rotation of the support member.

14. A holder according to claim 13 wherein the second support member has a main section having one end adapted to penetrate the ground and a collar section disposed adjacent the opposed end of the main section and capable of surrounding the support member, the collar section being provided with securing means arranged to releasably secure the collar section to the support member.
